(19) United States
(12) Patent Application Publication
(10) Pub. No.: US 2008/0076962 A1
(43) Pub. Date: Mar. 27, 2008

(54) Oxygen concentration control apparatus for incubator, and incubator using the same

(76) Inventors: Kazunori Miyagawa, Saitama-shi (JP); Masayuki Sato, Saitama-shi (JP); Kazuo Matsubara, Bunkyo-ku (JP)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/894,949

(22) Filed: Aug. 22, 2007

(30) Foreign Application Priority Data
Sep. 21, 2006 (JP) 2006-255636

(51) Int. Cl. A61G 11/00

(52) U.S. Cl. 600/22

(57) ABSTRACT

The present invention provides an oxygen concentration control apparatus for an incubator and an incubator using the same also suitable for continuous use for a long period. A pulse oximeter measures percutaneous arterial oxygen saturation (SpO₂) of a newborn accommodated in an incubator, and a control unit obtains fraction of inspired oxygen (FiO₂) used for setting the measured value of the percutaneous arterial oxygen saturation (SpO₂) obtained by the pulse oximeter to a predetermined set value. In the measurement of the percutaneous arterial oxygen saturation (SpO₂) by the pulse oximeter, it is unnecessary to warm the skin of a region to be measured. Consequently, even if the percutaneous arterial oxygen saturation (SpO₂) is measured continuously for a long period, there is low possibility that the accommodated newborn suffers a cold burn.

### CROSS REFERENCE TO RELATED APPLICATIONS

This patent application claims priority from Japanese Patent Application No. 2006-255636, filed on Sep. 21, 2006. This reference is incorporated herein by reference.

### STATEMENT REGARDING FEDERALLY SPONSORED RESEARCH

Not applicable.

### BACKGROUND OF THE INVENTION

1. Field of the Invention

The present invention relates to an oxygen concentration control apparatus for an incubator and to an incubator using the same. While measuring oxygen in arterial blood of a newborn accommodated in an incubator, the apparatus obtains oxygen fraction of inspired gas supplied to the accommodated newborn, which is used for setting the measured value to a predetermined set value, that is, a desired value.

2. Description of the Related Art

In oxygen therapy performed for preventing or treating hypoxia due to various causes in a newborn, the newborn is accommodated in an incubator. While measuring oxygen in arterial blood of the newborn, oxygen concentration, that is, fraction of inspired oxygen (FiO₂) in the incubator is controlled by controlling the mixing ratio of gaseous mixture of air and oxygen supplied into the incubator so that the measured value becomes a set value, that is, a desired value. In one related art of an oxygen concentration control apparatus for an incubator performing such a control, while measuring transcutaneous arterial oxygen pressure (tcPO₂) of a newborn, a gas mixer of air and oxygen is automatically controlled on the basis of the measured value (“Adaptive System for Oxygen Treatment of Newborn Infants”, Japanese journal of medical electronics and biological engineering, Vol. 21, Special number (1983), p. 190).

In the conventional oxygen concentration control apparatus for an incubator, transcutaneous arterial oxygen pressure (tcPO₂) of a newborn is measured. For the measurement, the skin of a region to be measured to which an oxygen electrode is adhered has to be heated to 43 to 44° C. However, when the transcutaneous arterial oxygen pressure (tcPO₂) is measured continuously for a long period even at the temperature of 43 to 44° C., a newborn whose skin has not sufficiently developed may suffer a cold burn. For this reason, the conventional oxygen concentration control apparatus for an incubator is not suitable for continuous use for a long period.

### BRIEF SUMMARY OF THE INVENTION

Therefore, an object of the present invention is to provide an oxygen concentration control apparatus for an incubator suitable for continuous use for a long period, and an incubator using the same.

In the oxygen concentration control apparatus for an incubator according to the present invention, a pulse oximeter measures percutaneous arterial oxygen saturation (SpO₂) of an accommodated newborn, and a control unit obtains fraction of inspired oxygen (FiO₂) used for setting the measured value of the percutaneous arterial oxygen saturation (SpO₂) obtained by the pulse oximeter to a predetermined set value. In the measurement of the percutaneous arterial oxygen saturation (SpO₂) by the pulse oximeter, it is unnecessary to warm the skin of a region to be measured. Consequently, even if the percutaneous arterial oxygen saturation (SpO₂) is measured continuously for a long period, there is low possibility that the accommodated newborn subjected to measurement of the pulse oximeter suffers a cold burn. Therefore, the oxygen concentration control apparatus for an incubator according to the present invention is also suitable for continuous use for a long period. The oxygen concentration control apparatus for an incubator according to the invention is particularly effective since an accommodated newborn is unlikely to suffer a cold burn even if the newborn has not sufficiently developed his/her skin.

In an incubator according to the invention, a second control unit supplies a valve regulating amount to an oxygen flow regulating valve so that fraction of inspired oxygen (FiO₂) as a measured value becomes equal to fraction of inspired oxygen (Set.FiO₂(t)) as a set value obtained by the control unit of the oxygen concentration control apparatus for an incubator. Therefore, the percutaneous arterial oxygen saturation (SpO₂(t)) of an accommodated newborn can be made close to the percutaneous arterial oxygen saturation (Set.SpO₂) as a desired value in a state where there is low possibility that the accommodated newborn suffers a cold burn.

In a preferred incubator according to the present invention, the fraction of inspired oxygen measuring device measures fraction of inspired oxygen (FiO₂) as a measured value. Therefore, by supplying the fraction of inspired oxygen (FiO₂) as a measured value obtained by the fraction of inspired oxygen measuring device and the fraction of inspired oxygen (Set.FiO₂(t)) as a set value obtained by the control unit of the oxygen concentration control apparatus for an incubator to the second control unit, the second control unit can supply the valve regulating amount to the oxygen flow regulating valve.

### BRIEF DESCRIPTION OF THE DRAWING

FIG. 1 is a schematic block diagram of one embodiment of the present invention.

### DETAILED DESCRIPTION OF THE PREFERRED EMBODIMENT OF THE INVENTION

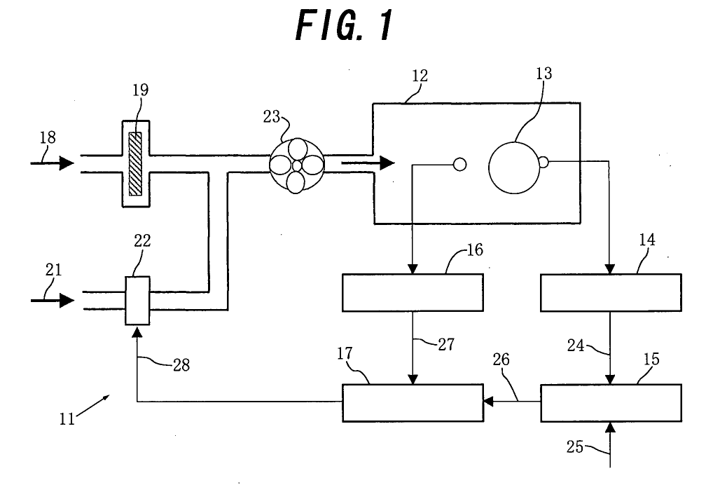

One embodiment of the invention will be described below with reference to the FIGURE. FIG. 1 shows the embodiment. An incubator 11 has therein a pulse oximeter 14, that is, a pulse oxygen measuring device for optically and percutaneously measuring percutaneous arterial oxygen saturation (SpO₂) of an accommodated newborn 13 as a newborn accommodated in the incubator 11, specifically in an accommodation space 12 covered with a transparent hood. The pulse oximeter 14 is connected to a control unit 15 such as a microcomputer. The incubator 11 has also therein a known fraction of inspired oxygen measuring device 16 for measuring fraction of inspired oxygen (FiO₂) in the accommodation space 12. The control unit 15 and the fraction of inspired oxygen measuring device 16 are connected to another control unit 17 such as a microcomputer.

The incubator 11 has therein a filter 19 for filtering air 18 taken from the outside and a flow regulating valve 22 for regulating flow rate of oxygen 21 supplied from a known oxygen supply source (not shown). The air 18 and the oxygen 21 pass through the filter 19 and the flow regulating valve 22 respectively and are then mixed with each other, and the gaseous mixture is sent into the accommodation space 12 by a blower 23. Therefore, by controlling the flow regulating valve 22, the oxygen concentration of the gaseous mixture sent into the accommodation space 12, that is, the fraction of inspired oxygen (FiO₂) is controlled. Although not shown, the gaseous mixture sent into the accommodation space 12 circulates in the accommodation space 12 and is mixed with fresh air 18 taken from the outside and fresh oxygen 21, and the resultant gaseous mixture is sent again into the accommodation space 12 by the blower 23.

In such an incubator 11, the pulse oximeter 14 measures percutaneous arterial oxygen saturation (SpO₂(t)) 24 of the accommodated newborn 13 and supplies the measured value to the control unit 15, at predetermined discrete sampling times “t” (for example, every 10 seconds). To the control unit 15, percutaneous arterial oxygen saturation (Set.SpO₂) 25 as a set value, that is, as a desired value predetermined for the accommodated newborn 13 is also supplied in advance by operation of a control board (not shown) of the incubator 11. The control unit 15 obtains fraction of inspired oxygen (Set.FiO₂(t)) 26 as a set value, that is, as a desired value in the accommodation space 12 at the sampling times “t” by the following equation (1) and supplies it to the control unit 17.

Set.FiO₂(t)=α(SpO₂(t)−Set.SpO₂)+(β/N)ΣSet.FiO₂(t−n) (1)

Each of α and β in the first and second terms in the right side of the equation (1) is a predetermined constant coefficient. N in the second term in the right side of the equation (1) denotes a value obtained by dividing an integration period by the sampling interval. For example, when the integration period is 20 minutes (=1200 seconds) and the sampling interval is 10 seconds as described above, N=120. Further, Σ in the second term in the right side of the equation (1) obtains the sum of n=1 to N. To avoid the risk of hypoxia even when Set.FiO₂(t)<21, Set.FiO₂(t)=21 which is equal to the oxygen concentration of atmosphere is set as the lower limit of oxygen concentration in the accommodation space 12. As oxygen concentration enabling stable supply in an actual incubator even when Set.FiO₂(t)>65, the upper limit of the oxygen concentration in the accommodation space 12 is set as Set.FiO₂(t)=65. Further, in the period of t−n<0, Set.FiO₂(t−n)=Set.FiO₂(0) is satisfied.

The first term in the right side of the equation (1) is a proportional control term obtained by multiplying the difference between the percutaneous arterial oxygen saturation (SpO₂(t)) 24 as the actual measured value of the accommodated newborn 13 and the percutaneous arterial oxygen saturation (Set.SpO₂) 25 as a predetermined set value, that is, as a desired value by the coefficient α. If the difference is positive, the control unit 15 operates to decrease the fraction of inspired oxygen (Set.FiO₂(t)) 26 as a set value, that is, as a desired value in the accommodation space 12. If the difference is negative, the control unit 15 operates to increase the fraction of inspired oxygen (Set.FiO₂(t)) 26 as a set value, that is, as a desired value in the accommodation space 12.

In accordance with the difference, the control unit 15 operates so as to change the fraction of inspired oxygen (Set.FiO₂(t)) 26 as a set value, that is, as a desired value in the accommodation space 12. Specifically, when the percutaneous arterial oxygen saturation (SpO₂(t)) 24 as the actual measured value of the accommodated newborn 13 is largely deviated from the percutaneous arterial oxygen saturation (Set.SpO₂) 25 as a predetermined set value, that is, as a desired value, the fraction of inspired oxygen (Set.FiO₂(t)) 26 as a set value, that is, as a desired value in the accommodation space 12 is largely changed. When the percutaneous arterial oxygen saturation (SpO₂(t)) 24 as the actual measured value of the accommodated newborn 13 is close to the percutaneous arterial oxygen saturation (Set.SpO₂) 25 as a predetermined set value, that is, as a desired value, the fraction of inspired oxygen (Set.FiO₂(t)) 26 as a set value, that is, as a desired value in the accommodation space 12 is changed only a little.

The second term in the right side of the equation (1) is an integral control term obtained by multiplying an average value ((1/N)ΣSet.FiO₂(t−n)) of the fraction of inspired oxygen (Set.FiO₂(t−n)) as a set value, that is, as a desired value obtained in the integral period, that is, at the N sampling times in the past by the coefficient β. Therefore, when the fraction of inspired oxygen (Set.FiO₂(t−n)) as a set value, that is, as a desired value in the past continues to be high, the second term is also high. When the set value in the past continues to be low, the second term is also low.

If the percutaneous arterial oxygen saturation (SpO₂(t)) 24 as the actual measured value of the accommodated newborn 13 is equal to the percutaneous arterial oxygen saturation (Set.SpO₂) 25 as a predetermined set value, that is, as a desired value, the first term in the right side of the equation (1) becomes zero. Consequently, the second term in which the average value of N times in the past is multiplied by the coefficient β becomes the fraction of inspired oxygen (Set.FiO₂(t)) 26 as the set vale, that is, as the desired value in the accommodation space 12.

On the other hand, the fraction of inspired oxygen measuring device 16 in the incubator 11 measures fraction of inspired oxygen (FiO₂) 27 in the accommodation space 12 and supplies the measured value to the control unit 17. The control unit 17 controls the flow regulating valve 22 by supplying a valve regulation amount 28 of the flow regulating valve 22 to the flow regulating valve 22 so that the fraction of inspired oxygen (FiO₂) 27 as a measured value supplied from the fraction of inspired oxygen measuring device 16 becomes equal to the fraction of inspired oxygen (Set.FiO₂(t)) 26 as the set value, that is, as the desired value supplied from the control unit 15.

Therefore, the control unit 15 obtains the fraction of inspired oxygen (Set.FiO₂(t)) 26 as the set value, that is, as the desired value in the accommodation space 12 by using the percutaneous arterial oxygen saturation (SpO₂(t)) 24 as the actual measured value of the accommodated newborn 13 and the percutaneous arterial oxygen saturation (Set.SpO₂) 25 as the predetermined set value, that is, as the desired value. The control unit 17 controls the flow regulating valve 22 so that the fraction of inspired oxygen (FiO₂) 27 as an actual measured value in the accommodation space 12 becomes equal to the fraction of inspired oxygen (Set.FiO₂(t)) 26 as the set value, that is, as the desired value. The percutaneous arterial oxygen saturation (SpO₂(t)) 24 of the accommodated newborn 13 accommodated in the accommodation space 12 in the incubator 11 becomes rapidly close to the percutaneous arterial oxygen saturation (Set.SpO₂) 25 as the predetermined set value, that is, as the desired value, and this state is stably maintained.

Although the above values are used as the sampling interval and the integral period for measuring the percutaneous arterial oxygen saturation (SpO₂(t)) 24 by the control unit 15 in the above embodiment, the invention is not limited to the values but may use other values.

The present invention can be utilized for manufacture or the like of an oxygen concentration control apparatus for an incubator and an incubator using the same. While measuring oxygen in arterial blood of a newborn accommodated in an incubator, the apparatus obtains oxygen fraction of inspired gas supplied to the accommodated newborn, which is used for setting the measured value to a predetermined set value, that is, a desired value.

1. An oxygen concentration control apparatus for an incubator, comprising:
a pulse oximeter for measuring percutaneous arterial oxygen saturation of a newborn accommodated in an incubator; and
a control unit for obtaining oxygen fraction of inspired gas supplied to the accommodated newborn, used for setting the percutaneous arterial oxygen saturation as a measured value of the pulse oximeter to percutaneous arterial oxygen saturation as a predetermined set value.

2. An incubator comprising:
a flow regulating valve for regulating flow rate of oxygen supplied, thereby regulating oxygen fraction of the inspired gas;
an oxygen concentration control apparatus according to claim 1; and
a second control unit for supplying a valve regulation amount to the flow regulating valve so that the oxygen fraction of the inspired gas as a measured value becomes equal to oxygen fraction of the inspired gas as a set value obtained by the control unit of the oxygen concentration control apparatus for an incubator.

3. The incubator according to claim 2, further comprising a fraction of inspired oxygen measuring device for obtaining the measured value.
